(19) United States
(12) Patent Application Publication
(10) Pub. No.: US 2026/0196717 A1
(43) Pub. Date: Jul. 9, 2026

(54) HYBRID MATERIAL-BASED SUBMARINE RADOME

(71) Applicant: KNS INC., Daejeon (KR)

(72) Inventors: Byeong Wook JIN, Daejeon (KR); Gil Sang RYU, Daejeon (KR); Young Sun KIM, Daejeon (KR)

(21) Appl. No.: 19/200,103

(22) Filed: May 6, 2025

(30) Foreign Application Priority Data
Jan. 3, 2025 (KR) 10-2025-0000597

(51) Int. Cl. H01Q 1/42; H01Q 1/34

(52) U.S. Cl. CPC H01Q 1/422; H01Q 1/34

(57) ABSTRACT

A hybrid material-based submarine radome may include: a cap hemisphere having an open interior; a cap cylinder having an open interior and having an insert provided on an inner perimeter thereof; a bracket; and a body, where the bracket can include a threaded part corresponding with the insert, the bracket can be secured to the cap cylinder in a manner of a screw, and the bracket can be formed from a metallic material. An embodiment of the invention can provide a submarine radome in which a material having a high wave transmittance and a material having a high strength are combined to simultaneously resolve the problems of low wave transmittance and vulnerability to damage in a high water pressure environment.

### CROSS-REFERENCE TO RELATED APPLICATIONS

This application claims the benefit of Korean Patent Application No. 10-2025-0000597, filed with the Korean Intellectual Property Office on Jan. 3, 2025, the disclosure of which is incorporated herein by reference in its entirety.

### BACKGROUND

### 1. Technical Field

The invention relates to a submarine radome based on a hybrid material, more particularly to a hybrid material-based submarine radome in which a quartz material and a titanium material are combined to simultaneously ensure strength and wave transmissibility and also provide watertightness at the coupling portions.

### 2. Description of the Related Art

A submarine radome is a structure that is designed to protect the satellite communication and radar systems of a submarine while also readily allowing wave transmissibility. Existing radome technologies mostly involve designs using a single material, but such designs are limited in their ability to maintain a balance between wave transmissibility and water pressure resistance.

In particular, a material having a high wave transmittance generally has a low strength and is thus easily damaged in a high water pressure environment, and conversely, a high strength material generally has a low wave transmittance and thus yields low communication performance. Also, the materials and coupling structures used in the related art are also subject to corrosion by seawater and difficulty in maintaining high airtightness.

Although a submarine radome manufactured from a material such as quartz or fiberglass can provide wave transmissibility, the high wave transmittance is overshadowed by its low pressure resistance and difficulty in forming a watertight structure, as the antenna would be damaged after a naval maneuver and thus would be incapable of satellite communication while at sea.

### SUMMARY OF THE INVENTION

An aspect of the invention is to provide a submarine radome in which a material having a high wave transmittance and a material having a high strength are combined to simultaneously resolve the problems of low wave transmittance and vulnerability to damage in a high water pressure environment.

Another aspect of the invention is to provide a submarine radome that displays airtightness and structural stability so as to be capable of long-term operations even in a high water pressure environment.

Another aspect of the invention is to provide a submarine radome that can minimize increases in fabrication costs while satisfying performance requirements.

Other objectives of the present invention will be more clearly understood from the embodiments set forth below.

One aspect of the invention provides a hybrid material-based submarine radome that includes: a cap hemisphere having an open interior; a cap cylinder having an open interior and having an insert provided on an inner perimeter thereof; a bracket; and a body, where the bracket includes a threaded part corresponding with the insert, the bracket is securable to the cap cylinder in a manner of a screw, and the bracket is formed from a metallic material.

The hybrid material-based submarine radome can further include a cap O-ring between the cap hemisphere and the cap cylinder.

The cap hemisphere can include a quartz material, and the cap cylinder can include a titanium material.

The cap hemisphere can further include: a coating layer containing polycarbonate; a quartz layer containing a quartz material; and a reinforcement layer containing a fiberglass reinforced polymer.

The quartz layer can have a thickness of 5~10 mm, and the cap cylinder can have a thickness of 15 mm~20 mm.

A first flange can be formed on a lower end of the cap hemisphere, a second flange can be formed on an upper end of the cap cylinder, the first flange and the second flange can be secured to each other by way of a fastener, the cap O-ring can be placed between the first flange and the second flange, and a silicone pad and a pad elastic element can further be provided between the first flange and the second flange.

The titanium material of the cap cylinder can include Ti—6Al—2Sn—4Zr—2Mo, where the titanium material of the cap cylinder can be thermally treated at 955~975° C. for 45~75 minutes, thermally treated at 565~590° C. for 8 hours, and thermally treated at 620~650° C. for 2 hours and can contain an α phase of 75 % or higher.

The second flange further can include an elastic seal bottom protruding from the second flange and having a bolt insertion hole, the elastic seal bottom can include a sloped portion, and the first flange can include: an elastic seal top protruding from the first flange and having a bolt insertion hole, an elastic element mounted in a compressed state in a spring mounting cavity of the elastic seal top when the first flange and the second flange are connected; a push gasket positioned between a push bar and the sloped portion of the elastic seal bottom to seal an interior of the radome when the first flange and the second flange are connected; and the push bar configured to compress the elastic element and push the push gasket towards the elastic seal bottom by using a compressive force of the elastic element.

An embodiment of the invention can provide a submarine radome in which a material having a high wave transmittance and a material having a high strength are combined to simultaneously resolve the problems of low wave transmittance and vulnerability to damage in a high water pressure environment.

An embodiment of the invention can also provide a submarine radome having airtightness and structural stability that can operate stably for prolonged periods even in a high water pressure environment.

An embodiment of the invention can also provide a submarine radome that satisfies performance requirements while minimizing increases in fabrication costs.

### BRIEF DESCRIPTION OF THE DRAWINGS

FIG. 1 is a cross-sectional view of a hybrid material-based submarine radome according to an embodiment of the invention in an assembled state.

FIG. 2 is a cross-sectional view of a hybrid material-based submarine radome according to an embodiment of the invention in a disassembled state.

FIG. 3 is a magnified view of the cap coupling part in a partially disassembled state.

FIG. 4 is a cross-sectional view illustrating the stacked structure of the cap hemisphere.

### DETAILED DESCRIPTION OF THE INVENTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed by the present invention. In the description of the present invention, certain detailed explanations of the related art are omitted if it is deemed that they may unnecessarily obscure the essence of the invention.

While terms such as “first” and “second,” etc., can be used to describe various components, such components are not to be limited by the above terms. The above terms are used only to distinguish one component from another.

The terms used in the present specification are merely used to describe particular embodiments and are not intended to limit the present invention. An expression used in the singular encompasses the expression of the plural, unless it has a clearly different meaning in the context. In the present specification, it is to be understood that terms such as “including” or “having,” etc., are intended to indicate the existence of the features, numbers, steps, actions, components, parts, or combinations thereof disclosed in the specification and are not intended to preclude the possibility that one or more other features, numbers, steps, actions, components, parts, or combinations thereof may exist or may be added. Certain embodiments of the present invention will be described below in more detail with reference to the accompanying drawings.

Also, terms such as “about”, “substantially”, etc., used in the specification are intended to represent closeness to the succeeding numerical value when a manufacturing tolerance or content-related allowable range is provided. The terms are used to prevent the occurrence of the unscrupulous infringer unjustly using the disclosed invention if the specification were to describe the invention using exact or absolute numerals to aid the understanding of the invention.

The invention is described below in further detail using certain embodiments. It should be appreciated, however, that these embodiments are presented merely to aid the understanding of the invention and that the scope of protection is not limited by these embodiments.

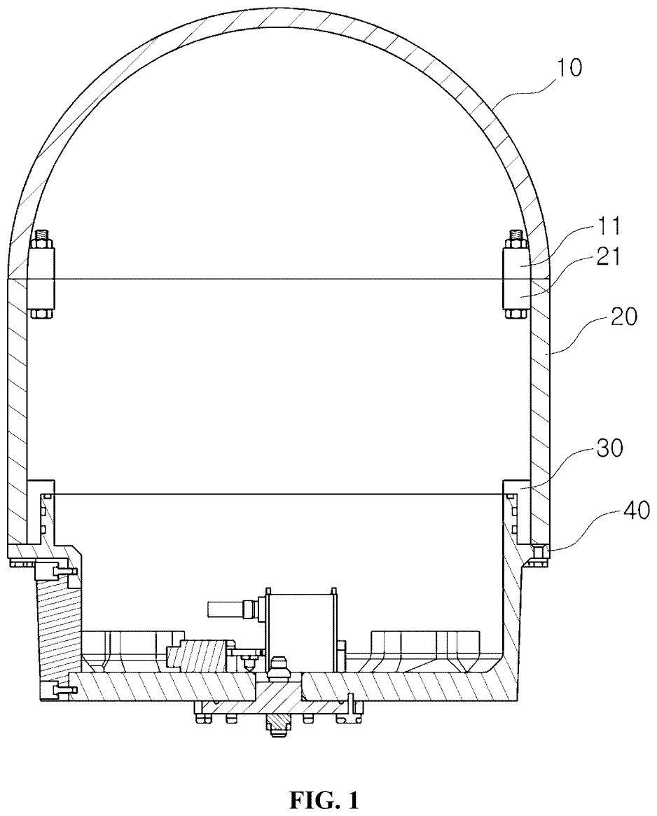

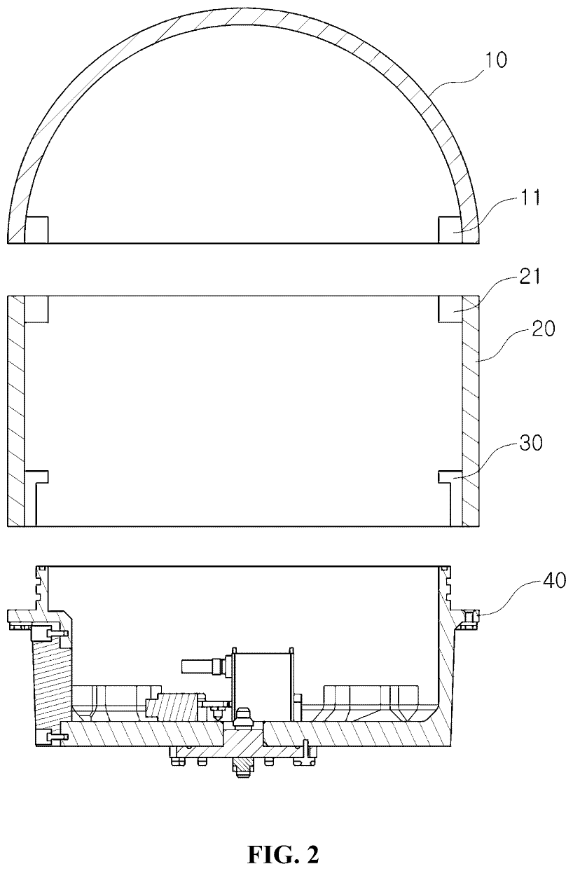

FIG. 1 and FIG. 2 conceptually illustrate the structure of a hybrid material-based submarine radome according to an embodiment of the invention. FIG. 1 illustrates the structure in an assembled state, and FIG. 2 illustrates the structure in a disassembled state.

A hybrid material-based submarine radome according to an embodiment of the invention may include a cap hemisphere 10, a cap cylinder 20, a bracket 30, and a body 40.

In a hybrid material-based submarine radome according to an embodiment of the invention, the radome may be divided into a cap hemisphere 10 having a domed shape and a cap cylinder 20 having a cylindrical shape.

The cap hemisphere 10 may be a dome-shaped part positioned on the uppermost end of the radome and may be the main portion through which satellite communication waves are transmitted.

A material that allows easy wave transmission may preferably be used for the cap hemisphere 10. Since the cap hemisphere 10 has a semispherical shape, its structural property enables the cap hemisphere 10 to easily withstand strong pressures applied from the exterior. Thus, even if a material that allows easy wave transmission is used for the cap hemisphere 10, the cap hemisphere 10 is capable of preventing damage from water pressures.

The cap cylinder 20 may have a cylindrical shape and thus can be structurally weaker compared to the cap hemisphere 10. Thus, a material having a high strength may preferably be used for the cap cylinder 20, so that the cap cylinder 20 may readily withstand water pressures.

The bracket 30 may have a cylindrical form that is open at the top and bottom so that its interior is in communication with the interior of the cap. The bracket 30 may have a threaded part corresponding with the insert of the cap cylinder 20 and may be structured to be secured to and installed on the cap cylinder 20 in the manner of a screw.

The bracket 30 may preferably be made from a metallic material for increased resistance to underwater pressures.

Preferably, one or more cap bracket O-rings may additionally be installed between the threaded parts on the cap bracket 30 corresponding to the cap 10 for a more airtight structure.

Also, the threaded part of the cap 10 may preferably be structured to be sealed with silicone.

A thread may be formed on the inner perimeter of the cap bracket 30 to allow a screw type coupling structure with respect to the body 40 described below.

The body 40 may be of a metallic material and may have a cylindrical form that is open only at the top. The body 40 may have a holding space therein, which space may be in communication with the interiors of the cap bracket 30, cap cylinder 20, and cap hemisphere 10.

A thread may be formed at one end on the outer perimeter of the body 40 to allow a screw type coupling structure with respect to the thread of the cap bracket 30.

Preferably, one or more body O-rings may additionally be installed on the body 40 corresponding to the cap bracket 30 for a more airtight structure.

A cap O-ring 211 can be provided at the connecting portions of the cap hemisphere 10 and the cap cylinder 20. The cap O-ring 211 can provide an airtight seal at the connecting portions of the cap hemisphere 10 and the cap cylinder 20.

The material of the cap O-ring 211 can be a polymer rubber. For example, the cap O-ring 211 can be fluorocarbon rubber (FKM), perfluoroelastomer (FFKM), or hydrogenated nitrile rubber (HNBR).

Fluorocarbon rubber is a material that is strong against salinity and has superb durability and is a material mainly used in offshore plants and submarine parts. Perfluoroelastomer (FFKM, Kalrez) is a material having high chemical resistance and very high durability in salinity and is a material that can maintain high durability in extreme environments. Hydrogenated nitrile rubber (HNBR) is a high-performance material based on nitrile rubber (NBR) and is a material having high water pressure resistance, high salinity resistance, high wear resistance, and high compression resistance. These materials are suitable for use as an O-ring under saline and high pressure conditions.

The cap hemisphere 10 can include a quartz material. Quartz offers a high wave transmittance and is suitable as the material for a satellite communication radome. Quartz displays a wave transmittance of about 90% or higher in the 8~12 GHz band, which band includes the X band and the Ku band. Quartz also has a high resistance to salinity and is thus suitable for use under seawater conditions.

The cap cylinder 20 can include a titanium material. Titanium, having a light weight compared to its strength, is capable of simultaneously providing a low weight and high strength and thus can aid in reducing the weight of a submarine radome while maintaining structural stability.

Also, titanium displays low deformation in high pressure environments, has a high compressional strength, and a low thermal expansion coefficient, making it suitable for deep sea conditions.

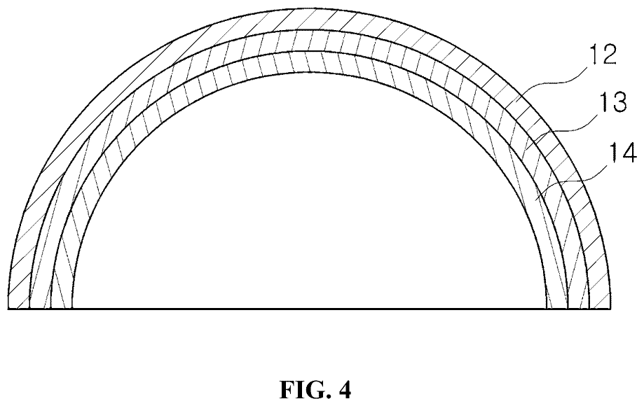

FIG. 4 is a cross-sectional view illustrating the stacked structure of the cap hemisphere 10. As seen in FIG. 4, the cap hemisphere 10 can further include a coating layer 12 that contains polycarbonate, a quartz layer 13 that contains a quartz material, and a reinforcement layer 14 that contains a fiberglass reinforced polymer.

While quartz has a high strength and high hardness, it is brittle and subject to shattering. That is, there is a need for treating the quartz material such that it is not shattered by the external impact given in a deep sea environment.

Thus, a cap hemisphere 10 according to an embodiment of the invention may apply a coating layer 12 containing polycarbonate onto the outer surface of the quartz layer 13 and apply a reinforcement layer 14 containing a fiberglass reinforced polymer onto the inner surface of the quartz layer 13.

The coating layer 12 can protect the cap hemisphere 10 from impact and wear and can increase resistance to factors that incur corrosion such as salinity. The coating layer 12 can also provide additional strength for the cap cylinder 20. However, since wave transmissibility is important in the cap hemisphere 10, a non-conductive material should be applied. As such, polycarbonate, which has a high hardness and strength but is a non-conductive material, can be a suitable material for the coating layer 12.

The reinforcement layer 14 can be installed to reinforce the structural strength of the overall cap hemisphere 10 and thus effectively disperse the external pressure in a high water pressure environment. Also, the reinforcement layer 14 can compensate for the brittleness of the quartz layer 13 and prevent shattering.

The reinforcement layer 14 can be formed in a uniform thickness as a coating applied on the inner surface of the quartz layer 13. Alternatively, the reinforcement layer 14 can be formed in a honeycomb structure on the inner surface of the quartz layer 13. In cases where the reinforcement layer 14 is formed in a uniform thickness on the inner surface of the quartz layer 13, the reinforcement layer 14 can act as a coating layer to prevent surface abrasion in the quartz layer 13, can prevent fragments from scattering even if shattering occurs, and can provide increased watertightness, but may slightly lower the wave transmittance of the quartz layer 13. In cases where the reinforcement layer 14 is formed in a honeycomb structure on the inner surface of the quartz layer 13, the reinforcement layer 14 can greatly increase strength by supporting the quartz layer 13 without causing a great loss in the wave transmittance of the quartz layer 13.

A description is provided below of a method of manufacturing a cap hemisphere 10 containing a quartz material.

First, artificial quartz may be grown through a hydrothermal process involving growing a silicate solution under high temperature high pressure conditions.

Then, the grown block-form quartz may be cut into a semispherical shape by using a cutting equipment.

Then, a quartz product of a semispherical form may be produced by polishing the outer surface of the semispherically shaped quartz and digging out the inside.

Then, the surface roughness of the inner surface and outer surface may be minimized by way of polishing.

Then, a thermal treatment may be applied to remove fine cracks in the quartz and increase durability. Here, the temperature for the thermal treatment may preferably be 800~1000° C., and the duration of the thermal treatment may preferably be 2~4 hours.

Then, a reinforcement layer 14 containing a fiberglass reinforced polymer may be attached onto the inside of the semispherical quartz product, and a coating layer 12 containing polycarbonate may be applied onto the outside.

Then, a flange may be attached or formed on the inner side of the semispherical quartz product.

While the method described above can be used to manufacture a cap hemisphere 10 containing a quartz material, this method is merely one of various examples, and the cap hemisphere 10 containing a quartz material is not limited to that manufactured by the above method.

In a hybrid material-based submarine radome according to an embodiment of the invention, the quartz layer 13 can have a thickness of 5~10 mm. Preferably, the quartz layer 13 of a hybrid material-based submarine radome according to an embodiment of the invention can have a thickness of 6~8 mm.

A thickness greater than 10 mm for the quartz layer 13 of the radome can result in a great increase in weight, a narrow interior space, and a reduced wave transmittance.

A thickness smaller than 5 mm for the quartz layer 13 of the radome can result in the quartz layer 13 becoming greatly brittle, to the extent of being easily shattered by even a small external impact.

Also, in a hybrid material-based submarine radome according to an embodiment of the invention, the thickness of the cap cylinder 20 can be 15~20 mm.

Preferably, the cap cylinder 20 of a hybrid material-based submarine radome according to an embodiment of the invention can have a thickness of 16~17 mm.

A thickness greater than 20 mm for the cap cylinder 20 would require a greater amount of titanium, leading to an increased weight, a considerable increase in cost due to the high cost of titanium, and a great decrease in machinability.

A thickness smaller than 15 mm for the cap cylinder 20 may not provide the required pressure resistance performance.

The coupling part between the cap hemisphere 10 and the cap cylinder 20 according to an embodiment of the invention is referred to herein as the cap coupling part. In an embodiment of the invention, a first flange 11 can be formed on a lower end of the cap hemisphere 10, and a second flange 21 can be formed on an upper end of the cap cylinder 20.

The first flange 11 and second flange 21 can be formed facing inward along the diameter direction of the cap or facing outward along the diameter direction of the cap. Here, the first flange 11 and second flange 21 can be formed inward along the diameter direction of the cap to prevent the flanges from being exposed to seawater.

A multiple number of first flanges 11 can be formed on the lower end of the cap hemisphere 10, and a multiple number of second flanges 21 can be formed on the upper end of the cap cylinder 20 at positions corresponding to the first flanges 11.

The first flanges 11 can be formed as integrated parts on the lower end of the cap hemisphere 10. At positions corresponding to those of the first flanges 11 on the upper end of the cap cylinder 20, the second flanges 21 can be formed as integrated parts of the cap cylinder 20. The first flanges 11 and second flanges 21 can be secured to each other by fasteners 215. The fasteners 215 can include bolts and nuts.

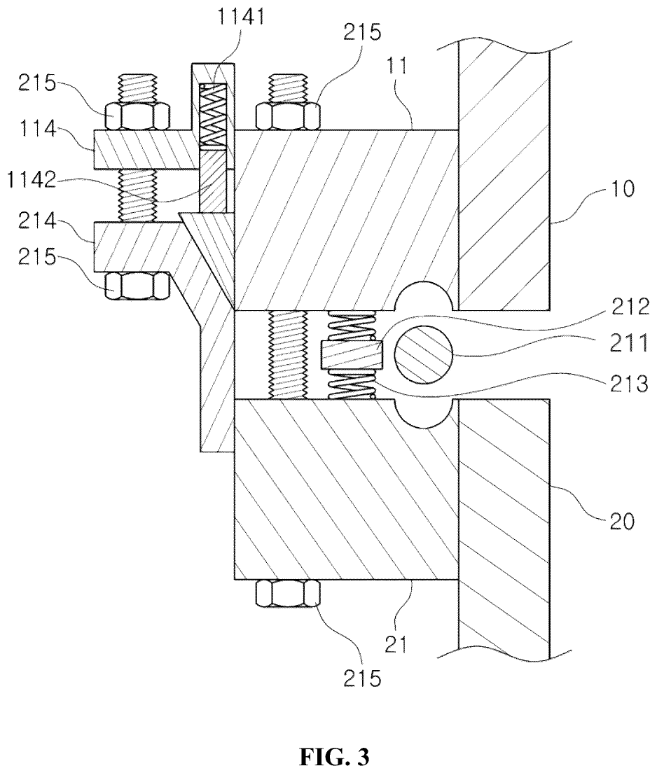

FIG. 3 is a magnified view of the cap coupling part in a partially disassembled state. Referring to FIG. 3, the first flange 11 can include an elastic seal top 114 for increasing the strength of the coupling with the second flange 21 and improving watertightness. An elastic element mounting cavity may be formed in the elastic seal top 114, and an elastic element 1141 can be provided in the elastic element mounting cavity. The elastic element 1141 may activate the push bar 1142 in a pushing direction, and the push bar 1142 can push a push gasket 1143 to apply pressure between the first flange 11, elastic seal bottom 214, and second flange 21 and thus ensure watertightness.

Also, as the elastic element 1141 pushes the push bar 1142, and the push bar 1142 in turn pushes the push gasket 1143, the push gasket 1143 may push the sloped portion of the elastic seal bottom 214 inward. Because of this, one side on the inside of the fastening hole in the elastic seal bottom 214 through which the fastener 215 is inserted can be pushed by the fastener 215, and the resulting increase in friction can prevent the fastener 215 from becoming loosened.

In short, the composition of the elastic seal top 114 and elastic seal bottom 214, which connect the first flange 11 and second flange 21 according to an embodiment of the invention, can improve watertightness and can prevent the loosening of the fasteners 215 which connect the cap hemisphere 10 with the cap cylinder 20.

The elastic element 1141 can be any element having an elastic property. The elastic element 1141 can be, for example, a spring, a polymer elastomer, rubber, a wound coil, or compressed air.

The push gasket can be of any material that can be slightly deformed by a compressive force to seal a space.

Preferably, silicone rubber or Teflon rubber can be employed as the push gasket.

A cap O-ring 211 can be placed between the first flange 11 and the second flange 21. Also, cavities can be formed in portions of the first flange 11 and second flange 21 at positions where the cap O-ring 211 is to be placed, so that the cap O-ring 211 may be placed therebetween.

Also, one or more pad elastic element 213 can be provided between the first flange 11 and second flange 21, and a silicone pad 212 can be provided on the pad elastic element 213. The pad elastic element 213 can press the silicone pad 212 to further improve the watertightness performance.

According to an embodiment of the invention, the silicone pad 212 can include a hydrophilic hygroscopic silicone material to absorb some of the seawater that may have infiltrated. The hydrophilic hygroscopic silicone material can absorb the seawater that infiltrates the cap O-ring 211 due to external water pressure and can thus aid in preventing the inflow of seawater to the interior of the cap hemisphere 10 and cap cylinder 20.

The titanium material for the cap cylinder 20 can be Ti—6Al—2Sn—4Zr—2Mo. The corresponding titanium material, also referred to as Ti-6242, is a titanium alloy that contains 6 weight % Al, 2 weight % Sn, 4 weight % Zr, and 2 weight % Mo. By applying this material, the cap cylinder 20 can be provided with both corrosion resistance and pressure resistance.

The titanium material for the cap cylinder 20 according to an embodiment of the invention can be thermally treated at 955~975° C. for 45~75 minutes, thermally treated at 565~590° C. for 8 hours, and thermally treated at 620~650° C. for 2 hours. Also, the titanium material for the cap cylinder 20 according to an embodiment of the invention can include an α phase of 75% or higher. Ti-6242 contains α-phase and β-phase titanium forming a microstructure. α-phase titanium is stable at normal pressure, has a superb high-temperature strength, and has superb oxidation resistance, but a low fatigue resistance. β-phase titanium has a relatively superior malleability and can provide flexibility for the overall titanium structure, increase workability, and remove brittleness.

However, if the α phase mentioned above is lower than 75 %, the strength of the cap cylinder 20 may become too low to withstand the water pressures of the deep sea environment. Therefore, the proportion of the α phase may preferably be kept at 75 % or higher.

The preferred embodiments of the present invention provided above are disclosed for illustrative purposes only. It should be appreciated that the skilled person having ordinary skill in regard to the present invention would be able to make various modifications, alterations, and additions without departing from the spirit and scope of the present invention and that such modifications, alterations, and additions are encompassed within the scope of claims below.

What is claimed is:

1. A hybrid material-based submarine radome comprising:
a cap hemisphere having an open interior;
a cap cylinder having an open interior and having an insert provided on an inner perimeter thereof;
a bracket; and
a body,
wherein the bracket includes a threaded part corresponding with the insert,
the bracket is securable to the cap cylinder in a manner of a screw, and
the bracket is formed from a metallic material.

2. The hybrid material-based submarine radome of claim 1, further comprising a cap O-ring between the cap hemisphere and the cap cylinder.

3. The hybrid material-based submarine radome of claim 2, wherein the cap hemisphere includes a quartz material, and the cap cylinder includes a titanium material.

4. The hybrid material-based submarine radome of claim 3, wherein the cap hemisphere further comprises:
a coating layer containing polycarbonate;
a quartz layer containing a quartz material; and
a reinforcement layer containing a fiberglass reinforced polymer.

5. The hybrid material-based submarine radome of claim 4, wherein the quartz layer has a thickness of 5~10 mm, and
the cap cylinder has a thickness of 15 mm~20 mm.

6. The hybrid material-based submarine radome of claim 5, wherein a first flange is formed on a lower end of the cap hemisphere,
a second flange is formed on an upper end of the cap cylinder,
the first flange and the second flange are secured to each other by way of a fastener,
the cap O-ring is placed between the first flange and the second flange, and
a silicone pad and a pad elastic element are further provided between the first flange and the second flange.

7. The hybrid material-based submarine radome of claim 6, wherein the titanium material of the cap cylinder comprises Ti—6Al—2Sn—4Zr—2Mo,
and wherein the titanium material of the cap cylinder is:
thermally treated at 955~975° C. for 45~75 minutes,
thermally treated at 565~590° C. for 8 hours, and
thermally treated at 620~650° C. for 2 hours,
and contains an α phase of 75 % or higher.

8. The hybrid material-based submarine radome of claim 7, wherein the second flange further comprises:
an elastic seal bottom protruding from the second flange and having a bolt insertion hole,
the elastic seal bottom includes a sloped portion,
and wherein the first flange comprises:
an elastic seal top protruding from the first flange and having a bolt insertion hole,
an elastic element mounted in a compressed state in a spring mounting cavity of the elastic seal top when the first flange and the second flange are connected;
a push gasket positioned between a push bar and the sloped portion of the elastic seal bottom to seal an interior of the radome when the first flange and the second flange are connected; and
the push bar configured to compress the elastic element and push the push gasket towards the elastic seal bottom by using a compressive force of the elastic element.
